(19) United States
(12) Patent Application Publication
(10) Pub. No.: US 2010/0025497 A1
(43) Pub. Date: Feb. 4, 2010

(54) Fluid flush device with optional telescopic wand

(76) Inventor: Jeffrey Dale Ellenbecker, Waukesha, WI (US)

Correspondence Address: Jeffrey Dale Ellenbecker, 1417 Madison Street, Waukesha, WI, 53188, US

(21) Appl. No.: 12/220,972

(22) Filed: Jul. 30, 2008

(51) Int. Cl. B05B 9/01

(52) U.S. Cl. 239/526

(57) ABSTRACT

One embodiment of a universal fitting or fittings connected to a handle which can be made up of various materials with a flow control trigger and trigger lock or hold. The wand and insulator with optional grip can also be made up of many and different materials, which leads to an optional telescopic wand and a longitudinally pitched end having a plurality of nozzles and other nozzle assemblies.

### FEDERALLY SPONSORED RESEARCH

Not Applicable

### SEQUENCE LISTING OR PROGRAM

Not Applicable

### BACKGROUND

1. Field of the Invention

The present invention relates generally to spray cleaning devices. More particularly, it relates to a device for flushing and cleaning the under part of any surface or object that the user chooses using a fluid.

2. Prior Art

Any discussion of the prior art through-out the specification should in no way be considered as an admission that such prior art is widely known or forms part of common general knowledge in the field.

There are many devices that utilize water or other fluids to clean or rinse deposits such as salt and dirt from the under carriage of a vehicle that pose difficulties.

With the use of only traditional garden hoses or a straight wand, it is awkward to thoroughly clean the underside of a vehicle or such other object. Many devices have been developed to clean the underbody of an automobile but they are limited for many other uses. The majority of devices have a multiplicity of parts, including wheels and casters or other devices for rolling the device along the ground and under the vehicle. Less complicated devices have a limited fluid spray area or a limited number of orifices rendering the fluid spray coverage area inadequate. A number of devices have been developed for directing a spray of liquid underneath the underbody of a vehicle while also allowing the user of the device to remain standing upright. Such devices pose problems as well.

For example, U.S. Pat. No. 6,079,640 to Merritt describes and claims that the user can use the device for cleaning the underside of an automobile in an upright position. Although this device allows a user to stand upright, the device is 6.5 feet in length and is comprised of an integral, one piece tube without a flow-control trigger to control the water flow also limiting the users due to its length. Being a one piece tube at 6.5 feet in length does not make it compatible or as universal as it should be to fit the everyday user's needs and sizes. Merritt also states that the device is to be used with an ordinary garden hose which also limits the amount of users because of the amount of pressure or velocity that can be used for different circumstances.

U.S. Pat. No. 6,755,361 to Danielson et al describes an adjustable spray apparatus at the spray end, which has limited spray area due to the limited amount of orifices rendering the spray coverage area problematical for the undercarriage. Danielson et al also states that it is an attachment to a high pressure liquid source such as a car wash wand which limits the average consumer who only has a garden hose. With this device not being universal, it poses a problem due to limitations.

In FIG. 4 of Danielson et al, motion C shows the handle upside down, which poses difficulties to the user seeing that the handle and trigger is actually upside down. Even if equipped with a swivel (as mentioned) to adjust the swivel and the spray apparatus, this configuration just complicates things more to the average user with all these moving parts.

U.S. Pat. No. 4,984,746 to Joyal describes a T-shape frame mounted on a plurality of wheels including at least one castor wheel, a plurality of pivoting or rotating spray nozzles on the base of the T-shape frame, and a handle having means for connection to a liquid cleaner supply.

U.S. Pat. No. 4,580,726 to Unger also has caster wheels which could pose problems used anywhere else but on a flat concrete surface.

Appealingly, a device designed to conveniently clean an underbody of a vehicle, wheel wells etc. to remove debris and such, also be used to clean underneath anything else that the user might choose would be ideal. It would also be desirable to devise such a device such that it can be used in any application, and to be universal to each and every user. In the view of this inventor, none of the above-described devices are believed to be universal to not only traditional garden hoses, pressure washers, self serve car washes or alike but to only one source. To be universal, and to fit the everyday users needs and to provide the necessary advantages, is the purpose of this invention.

### SUMMARY OF THE INVENTION

The underbody flush, or under part of any surface or object that the user chooses, apparatus of the present invention overcomes the problems associated with prior art. It is universal and will be able to be used with traditional garden hoses, pressure washes, self-serve car washes and any other water or chemical source and alike. It would also include an option that the wand be telescopic to fit different users of all shapes, sizes and uses. It will have many orifices to provide maximum coverage area with the proper velocity with water, or chemical and alike source. The user will be able to use it universally for not only as an underbody flush, but as a device for any under part of any surface of object or alike. With the present invention, there are no limitations due to it being universal for any application of washing the hard to reach, and being able to be used with the traditional garden hose, pressure washer, self-serve car wash and any other water or chemical source and alike. None of the above inventions and patents seems to describe the instant invention claimed. Thus, a universal under washer solving the aforementioned problems is desired.

The present invention is an underbody water flush or under wash of any surface or object that the user chooses with optional telescopic wand which can be used with a garden hose, pressure washer, self-serve car wash or any other water or chemical source comprising of multiple or universal fittings and a handle with a flow control trigger.

A tubular wand that consists of a heat insulator for hot water uses, option of a handle, and can also be telescopic to fit the many users and uses is provided. The lower embodiment of the device has a plurality of orifices. Each orifice has a nozzle assembly that emits a conical, precise spray in more dispensed, effective patterns. The lower end that is aligned longitudinally is slightly pitched to continue the effective pattern for not only the use of an underbody flush, but as an under wash of any surface or object that the user chooses. It will also vary in lengths to fit the user needs and to be universal.

It is an object of the present invention to provide improved elements and arrangements thereof for the purpose described which is inexpensive, dependable and fully effective in accomplishing its intended, multiple purposes, and to be universal for each and every user.

It is another object of the invention to provide a device for comfort, durability, effectiveness, efficiency, universal, etc. to clean, flush, rinse and wash. It is still another object to prevent unnecessary repairs by inhibiting corrosion and deterioration of under exposed surfaces of objects or to what the user intents the use, and to be universal and transportable for any application or use.

These and other objects of the present invention will become readily apparent upon further review of the following specification and drawings.

### BRIEF DESCRIPTION OF THE DRAWINGS

FIG. 1 is a side elevational view of one embodiment of the under surface washer of the present invention as it would be connected to any water or chemical source and the like.

FIG. 2 is a partial and enlarged top plan view of many orifices and their position on one embodiment of the device of the present invention.

FIG. 3 is a cross sectioned view of that portion of the device shown in FIG. 2.

FIG. 4 is another partial enlarged perspective view of an exemplary nozzle assembly inserted into the nozzle portion of the device.

FIG. 5 is yet another partial enlarged perspective view of an alternative exemplary orifice, nozzle assembly, and their positions used in the nozzle portion of the device.

FIG. 6 is still another partial perspective view of one embodiment of the invention.

FIG. 7 is a side elevational view of one embodiment of the device with the use of the optional telescopic wand.

FIG. 8 is a side elevational view of a person using one embodiment of the invention to wash under a variety of under surfaces.

FIG. 9 is another side elevational view of a person using one embodiment of the invention to wash under an automobile, recreational vehicle, equipment or the like.

### DRAWINGS—REFERENCE NUMERALS

| | | | |
|---|---|---|---|
| 10 | Present invention | 12 | Universal fittings or fitting |
| 14 | Water of chemical source | 16 | Trigger hold |
| 18 | Handle | 20 | Flow - Control trigger |
| 22 | Wand fittings | 24 | Insulator |
| 26 | Optional grip | 28 | Wand |
| 30 | Orifices | 32 | Longitudinally pitched end |
| 34 | Angle nozzle assembly | 36 | Nozzle that fits in orifices |
| 38 | Telescopic assembly | 40 | User |
| 42 | Object | 44 | Auto mobile or alike |

### DETAILED DESCRIPTION OF THE PREFERRED EMBODIMENTS

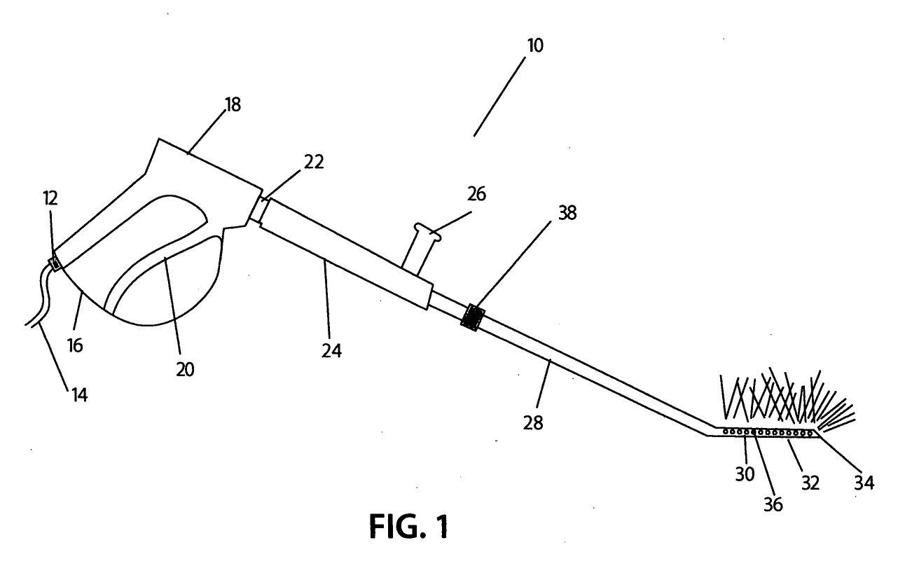

The present invention is shown in FIGS. 1 through 9. The underbody water flush or under wash of any surface or object that the user chooses with optional telescopic wand is designated generally as 10. As shown in FIG. 1, the present invention 10 comprises of a water or chemical source or alike 14 that connects to the handle 18 using a universal fitting 12. The handle 18 also consists of a flow-control trigger 20, a trigger hold 16 for constant pressure, and fittings for the wand 22. Once the wand 28 connects to the handle 18 using the fitting 22, there is an insulator 24 and optional grip 26. From here, there is also an option for a telescopic wand 38 that leads to a longitudinally pitched end 32. Defined within the end 32 there are many orifices 30 that have nozzles 36 to fit into those orifices 30 for maximum spray coverage. At the pitched end 32 there is an angled nozzle assembly 34.

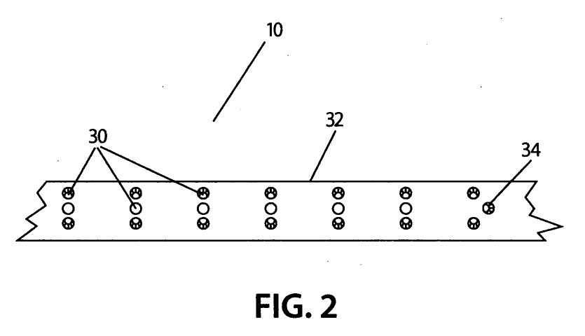

In FIG. 2, it will be seen that the pitched end 32 consist of orifices 30 and an angle orifice 34 where nozzles 36 fit into. Nozzles 36 could be placed in the end 32 as the user chooses with plugs to adjust the direction of the spray or to adjust the velocity. The angled nozzle assembly 34 could be specifically placed (such as angled) to achieve maximum coverage of the cleaning area.

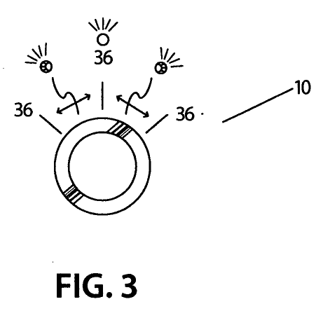

FIG. 3 illustrates one variation of the orifice arrangement 30 where the nozzles 36 will be placed for maximum coverage. Nozzles 36 also can be placed between the arrows shown in FIG. 3 to provide more nozzles 36 and more spray coverage.

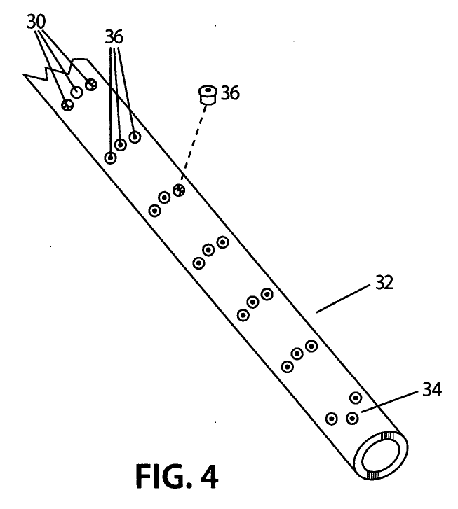

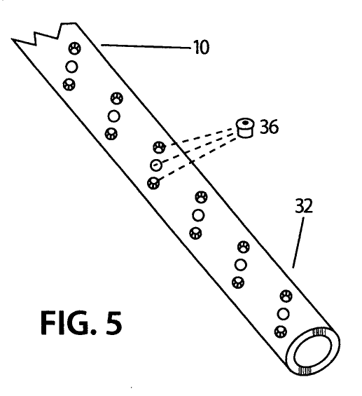

FIG. 4 shows the nozzle assembly 36 of the pitched end 32. The orifices 30 are placed strategically and then the nozzles 36 are placed therein. In an alternative embodiment, as shown in FIG. 5, the longitudinally pitched end 32 comprises of many orifices 30 which has a nozzle assembly 36 inserted therein. Nozzle assemblies 36 are conventional nozzles well known in the prior art which direct the liquid cleaner upwards in a conical spray.

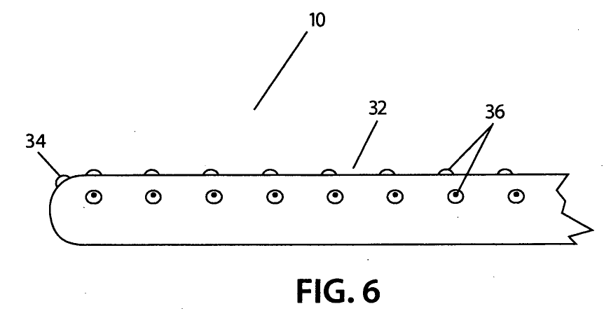

FIG. 6 illustrates another view of the pitched end 32 showing the nozzles 36 in the orifices 30 and the angled nozzle assembly 34.

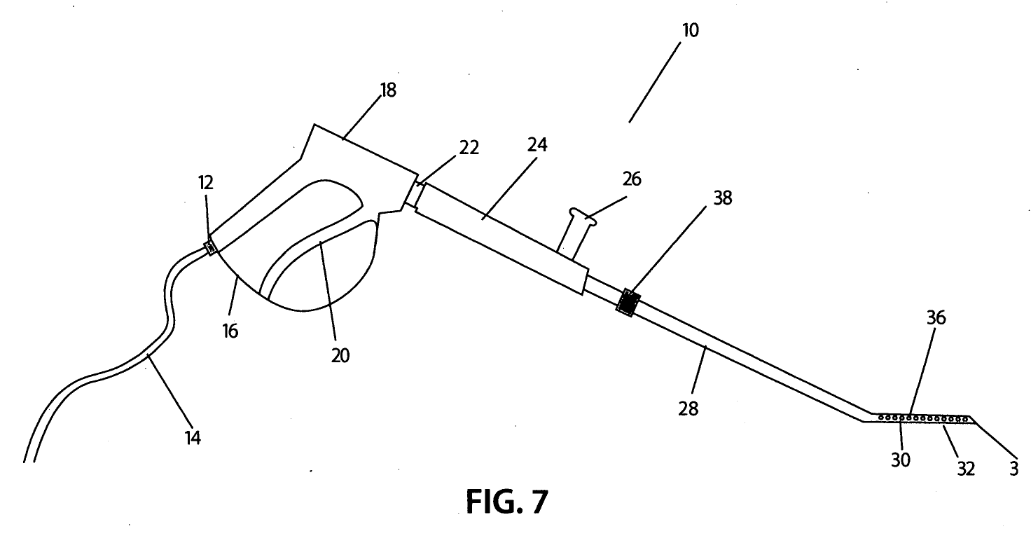

FIG. 7 shows the present invention 10 similar to that shown in FIG. 1, but with the optional telescopic wand 38 made longer.

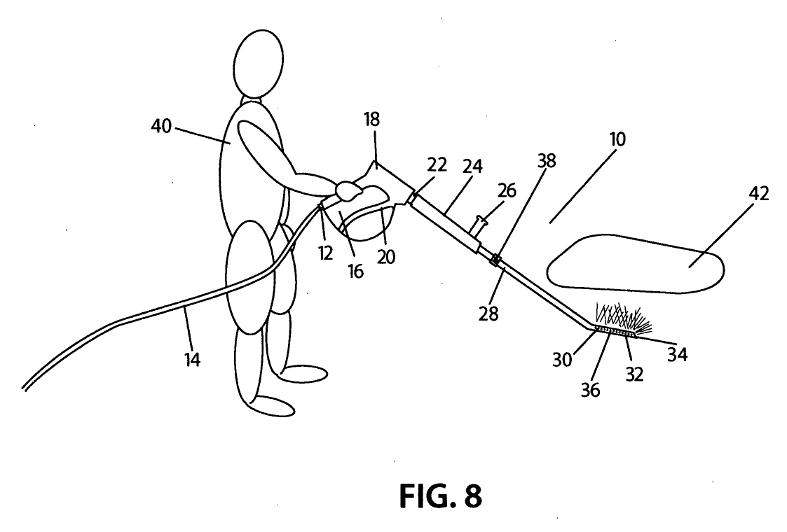

In FIG. 8, a person or user 40 is illustrated as being able to use the novel apparatus 10 in a variety of uses, seeing that the object 42 can be anything that the user 40 chooses.

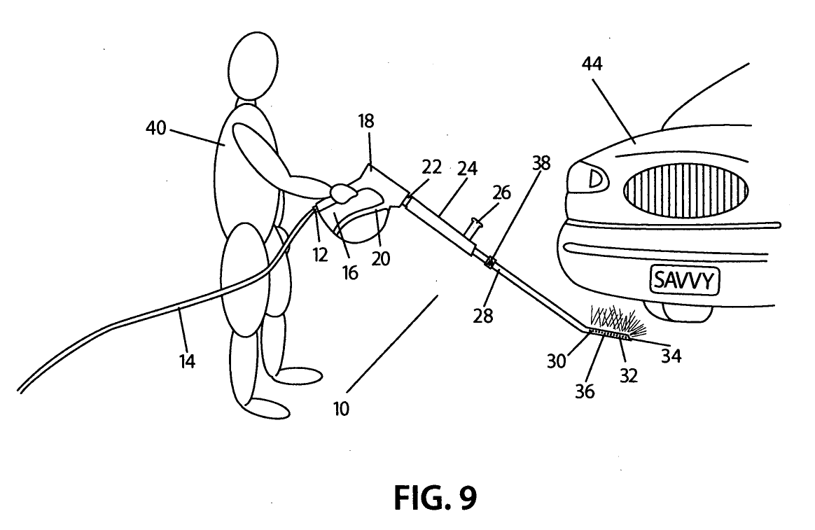

In FIG. 9, a person or user 40 is illustrated again being able to use the novel apparatus 10 in a variety of uses. An automobile or the like 44 is just one example for its use.

### Advantages

From the description above, a number of advantages of some embodiments of the underbody water flush or under wash of any surfaces or object that the user chooses with optional telescopic wand of the present invention become evident.
(a) With having universal fittings, it can be used for pressure washers or alike, traditional garden hoses, and self serve car washes. It is completely universal where the user can use for any application.
(b) The handle and trigger assembly is designed to fit comfortably in the user hands for maximum effectiveness for prolonged use.
(c) Being telescopic will provide a superior use because of how universal it is. With any user no matter their age, size, gender, and etc, it can be hooked up to any water or chemical source while being used for anything the operator chooses.
(d) The lower portion of the device will be slightly pitched with an angled nozzle assembly to produce maximum coverage and velocity.

### Conclusion, Ramification and Scope

Accordingly, the reader will see that, with the device of the present invention, various embodiments can be used effectively and universally for various liquid supplies, used on various objects, and made comfortably for any user no matter what size, shape or gender. Furthermore, the present invention has the additional advantages in that
It permits multiple uses for multiple jobs which will help control the extra cost for different cleaning or rinsing equipment.
It permits effective high pressure which aids in removing the deposits in which the user intends to remove.
It provides extra comfort to each user by being telescopic. The user can adjust to each application instead of his body adjusting.
It also can be universal to any liquid supplies and not being limited only to one source.

Although the description above contains many specifics, these should not be construed as limiting the scope of the embodiment but as merely providing illustration of some of the presently preferred embodiment. For example, the handle can be other shapes and sizes to be adjusted for comfort, and trigger control could be multiple fittings to fit or be designed to fit the specific needs of the user, etc. The telescopic wand can be made out of multiple polymeric material, etc. Also, the telescopic can be placed in multiple locations on the present invention. The orifices can be placed at different angles as well as the quantity of the orifices can be changed.

Thus the scope of the embodiment should be determined by the appended claim and their legal equivalent, rather by the examples given.

The principles of this invention having been described in accordance with the foregoing, I claim:

1. A fluid flush device with optional telescopic wand which comprises:
a) a universal fitting adapted for connection to a pressurized liquid, which connects to;
b) the handle and flow-control trigger which attaches to;
c) a wand, with the lower end optionally being;
d) longitudinally pitched having a plurality of orifices so that the lower end emits a multi-job spray; and wherein:
e) the length of the wand and modified “optional” telescopic body are dimensional for operation of said underbody water flush or under wash of any surface or object that the user chooses with optional telescopic wand by an operator standing in an upright position; and
f) said plurality of orifices extended longitudinally along the length of the longitudinally pitched end in a plurality of rows, the plurality of rows being separated by an angle and a spacing between orifices with an angled nozzle assembly.

2. The device of claim 1, further compromising:
a) the handle with a flow-control trigger and trigger lock; and
b) wand fitting to connect the handle to the wand; and
c) a insulator and optional hand grip around the upper half of wand; and
d) wand consist of optional telescopic wand to help the operator to stand in an upright position; and
e) at the length of the longitudinally pitched end an angled nozzle assembly.

3. The device of claim 2, wherein said handle can be made from metal, plastic, rigid synthetic polymeric material, or malleable metal alloy.

4. The device of claim 3, wherein said wand can be made from metal, plastic, rigid synthetic polymeric materials, or malleable metal alloy.

5. A fluid flush device with optional telescopic wand which comprises:
a) a universal fitting adapted for connection to a pressurized liquid, which connects to;
b) the handle and flow-control trigger which attaches to;
c) a wand, with the lower end optionally being;
d) longitudinally pitched having a plurality of orifices so that the lower end emits a multi-job spray; and wherein:
e) the length of the wand and modified “optional” telescopic body are dimensional for operation of said underbody water flush or under wash of any surface or object that the user chooses with optional telescopic wand by an operator standing in an upright position; and
f) plurality of orifices extended longitudinally along the length of the longitudinally pitch end in a plurality or rows, the plurality of rows being separated straight across and spacing between orifices with an angle nozzle assembly.
